(19) United States
(12) Patent Application Publication
(10) Pub. No.: US 2024/0405799 A1
(43) Pub. Date: Dec. 5, 2024

(54) TECHNIQUES FOR POWER EFFICIENT AND SMART ECHO CANCELLATION

(71) Applicant: HUAWEI TECHNOLOGIES CO., LTD., Shenzhen (CN)

(72) Inventor: Sujan Pandey, Munich (DE)

(21) Appl. No.: 18/799,827

(22) Filed: Aug. 9, 2024

Related U.S. Application Data
(63) Continuation of application No. PCT/EP2022/053386, filed on Feb. 11, 2022.

(51) Int. Cl. H04B 3/23

(52) U.S. Cl. CPC H04B 3/23

(57) ABSTRACT

The disclosure relates to techniques for power efficient and smart echo cancellation. An apparatus is provided that comprises a finite impulse response filter having a set of M+1 filter coefficients for filtering values of a reference signal to obtain a first filtered reference signal. The apparatus comprises an interval selector for selecting values of the reference signal associated with a k-th time interval of an echo impulse response having N time intervals. The apparatus comprises M delay elements arranged after the interval selector for successively delaying the selected values. The apparatus comprises M+1 error estimators. A first error estimator is coupled to an output of the interval selector. Each of the remaining M error estimators is coupled to an output of a respective delay element. The M+1 error estimators are configured to determine the M+1 filter coefficients to minimize deviation between the first filtered reference signal and the received signal.

### CROSS-REFERENCE TO RELATED APPLICATIONS

This application is a continuation of International Application No. PCT/EP2022/053386, filed on Feb. 11, 2022, the disclosure of which is hereby incorporated by reference in its entirety.

### TECHNICAL FIELD

The present disclosure relates to techniques for power efficient and smart echo cancellation, in particular with on-board diagnostic capability, e.g., for usage in automotive, industrial and consumer electronics. The disclosure particularly relates to an apparatus and a method for determining filter coefficients for an echo compensation filter for reduction of an echo signal in a communication channel with a long impulse response extending over N time intervals.

### BACKGROUND

Wired based high speed serial communication PHYs (physical interfaces) 110, 120 exchange data over cable 130 with a maximum length as defined by standards, e.g., IEEE 802.3cy, as illustrated in FIG. 1. The length of the cable 130 can vary from a fraction of a meter up to 100 m and higher. The cable 130 is usually divided into different segments and connected via inline connectors 131 as shown in FIG. 1. As the impedance changes at the connection point 131, 132 between cable and connector, the transmitted signal 112 is reflected back as echo signal 123. In full duplex communication systems, the reflected echo signal 123 is superimposed on top of the received signal 122. The reflected echo signal 123 needs to be cancelled out at the receiver.

Finite Impulse Response (FIR) based digital echo cancellation removes the reflected signal 123 from the received signal 122 using signal processing algorithms. The number of taps of the FIR filter depends on the length of the cable 130 and the Baud Rate. Channel behavior changes over time, thus an adaptive cancellation is required. As the data rate increases, the number of FIR filter taps for echo cancellation explodes. For example, for 100BASE-T1 and 1000BASE-T1 echo cancellation can still be handled. However, for 10G/25GBASE-T1, digital echo cancellation can be really complex because an echo cancellation implementation with about 5600 taps is a really complex task, in particular when using a number of echo taps that is equal to the complete length of the echo response. In such a case, the implementation becomes complex and extremely power consuming.

### SUMMARY

The disclosure provides a solution for a significant reduction of the echo signal in a communication channel, e.g., a wired based high speed serial communication channel as shown in FIG. 1 in order to overcome the above-described problems.

In particular, the disclosure provides a concept for a significant reduction of the number of echo taps compared to an echo compensation that covers the full echo response.

The focus of this disclosure lies on a technique reducing the need of covering full window length echo taps for echo cancellation in order to reduce the power, complexity, and silicon area. The whole echo response is divided into a number of segments and an echo cancellation block is designed that covers the first segment. At the beginning of communication, the echo is estimated and cancelled for the first segment. Once the coefficients reach their steady state values, then the coefficients are freezed, i.e., kept unchanged, and the process moves to the second segment to detect if there are any significant echoes to be cancelled. Similarly, the process is repeated from the first segment to the last segment and repeated again. The coefficients are updated based on a known adaptive algorithm, e.g., the least mean squares (LMS) algorithm. The second segment does not have to be contiguous to the first segment in the echo response, it can be any segment of the echo response other than the first segment.

Such technique significantly reduces the number of echo taps compared to a required number of echo taps when covering the full echo response. Compared to the full echo response compensation the same performance can be maintained for this novel technique disclosed hereinafter.

The solution presented in this disclosure is based on the following points: 1) The capability to detect and cancel echo without using full length of echo tap at signal processing block. 2) Applying a technique that reuses the limited number of echo taps to detect and cancel the echo that are spread over the echo response. 3) Applying a technique that decides the detected echo needs to be cancelled or can be left as un-cancelled echo. 4) A method that shifts the window of FIR filter from segment to segment once the coefficients reach its steady state value.

The concept described in this disclosure can be applied in automotive applications using wired-based data communication links, e.g., Ethernet cables such as defined by 1000BASE-T1, 10GBASE-T1, and future 25GBASE-T1. As there is a need of more and more bandwidth for the future autonomous vehicle to reliably transmit sensors data to the central processing unit, techniques according to the disclosure can be advantageously applied to improve efficiency of data transmission.

Apart from automotive, the technology described herein can also be applied in industrial and automation applications as well as consumer electronics.

In order to describe the disclosure in detail, the following terms, abbreviations and notations will be used:
PHY physical layer device or physical interface
MII Medium Independent Interface
DAC Digital to Analog Converter
LMS Least Mean Squares (algorithm)
FIR Finite Impulse Response (filter)

According to a first aspect, the disclosure relates to an apparatus for determining filter coefficients for an echo compensation filter for reduction of an echo signal in a communication channel upon a basis of a received signal, the received signal being a receivable version of a known reference signal transmittable over the communication channel, the receivable version of the reference signal being affected by the echo signal, wherein an impulse response of the communication channel extends over N time intervals, the apparatus comprising: a finite impulse response filter having a set of M+1 filter coefficients, the finite impulse response filter being configured to filter values of the reference signal using the M+1 filter coefficients to obtain a first filtered reference signal; an interval selector for selecting values of the reference signal associated with a k-th time interval of the N time intervals; M delay elements for successively delaying the selected values of the reference signal, the M delay elements being arranged after the interval selector; and M+1 error estimators, wherein a first error estimator is coupled to an output of the interval selector, and wherein each of the remaining M error estimators is coupled to an output of a respective delay element, wherein the M+1 error estimators are configured to determine the M+1 filter coefficients such that a measure of a deviation between the first filtered reference signal and the received signal is minimized.

M can be any integer number. A time interval may comprise a plurality of sample values, for example corresponding to the number of filter coefficients M+1. The number N of time intervals can be any integer number, for example greater than 1. The k-th time interval can be any of the N time intervals, e.g., selected by a controller.

Such an apparatus can reduce echo cancellation complexity due to the interval selection by the interval selector and thus results in low power and less silicon area.

The apparatus significantly reduces the number of echo taps compared to a required number of echo taps when covering the full echo response. Compared to the full echo response compensation the same performance can be maintained when using the disclosed apparatus.

The apparatus can be advantageously applied in wired full duplex chip to chip communication, for example.

In an exemplary implementation of the apparatus, the M+1 error estimators are mean squares error estimators, in particular least mean squares error estimators or minimum mean square estimators.

This provides the advantage that well known iteration procedures can be applied to update the filter coefficients. Such iteration procedures are easily available in software libraries. These procedures can guarantee fast convergence of the filter coefficients even in time variant environments.

In an exemplary implementation of the apparatus, the measure of the deviation between the first filtered reference signal and the received signal is a mean square deviation between values of the first filtered reference signal and the received signal.

This provides the advantage that the error signal is minimized. The filter represents a precise model of the communication channel.

In an exemplary implementation of the apparatus, the apparatus comprises a memory for storing the M+1 filter coefficients for the values of the reference signal selected by the interval selector.

This provides the advantage that the actual filter coefficients processed for the respective time interval of the impulse response can be stored in the memory for later usage. Thus, a successive determination of all filter coefficients of the full impulse response of the communication channel can be performed without increasing computation complexity.

In an exemplary implementation of the apparatus, the memory is configured to store the M+1 filter coefficients for each time interval of the N time intervals applied by the interval selector.

By storing the filter coefficients for each time interval, all filter coefficients of the full impulse response of the communication channel can be stored in the memory and a compensation accuracy is increased when filtering with the whole set of filter coefficients. However, chip size can be designed for processing only one or two time intervals of the full impulse response at a time.

In an exemplary implementation of the apparatus, the memory is configured to store the M+1 filter coefficients together with the value of the k-th time interval applied by the interval selector.

This provides the advantage that each set of M+1 filter coefficients is stored in the correct sequence. This simplifies a later access to the filter coefficients by a full impulse response compensation filter.

In an exemplary implementation of the apparatus, the M+1 error estimators are configured to determine the M+1 filter coefficients for which the measure of deviation between the first filtered reference signal and the received signal is below a predefined threshold.

This provides the advantage that an accuracy for the filtering can be adjusted or preconfigured. The convergence time of the filter can be flexible adjusted by defining a threshold.

In an exemplary implementation of the apparatus, the apparatus comprises a subtractor configured to determine the measure of deviation based on a subtraction of the first filtered reference signal from a digital representation of the received signal.

This provides the advantage that the error signal can be easily determined by a simple subtraction of the filtered signal, i.e., the first filtered reference signal, from the digital received signal, i.e., the digital representation of the received signal. The subtraction is performed in the digital domain.

In an exemplary implementation of the apparatus, the apparatus comprises an echo compensation filter having a set of N times M+1 filter coefficients, the echo compensation filter being configured to filter values of a transmit signal transmittable over the communication channel by using the M+1 filter coefficients for each time interval of the N time intervals.

This provides the advantage that the different filter sets of M+1 filter coefficients as determined for each time interval selected by the interval selector can be used for compensating the full echo impulse response. Hence, echoes at different time interval positions in the impulse response of the communication channel can be compensated.

In an exemplary implementation of the apparatus, the apparatus comprises a controller configured to send a select signal to the interval selector for selecting a value of the k-th time interval applied by the interval selector.

This provides the advantage that the interval selector can be flexible controlled by the controller. For example, a sequential filtering of the different time intervals or time segments can be performed or special time intervals can be preferred to be filtered, e.g., time intervals in which known echoes are located.

In an exemplary implementation of the apparatus, the apparatus comprises a plurality of spare resources for increasing the number of filter coefficients of the finite impulse response filter.

This provides the advantage that the accuracy of the FIR filter can be flexibly adapted. For example, if a high precision of echo compensation is required, the number of filter coefficients can be increased by additionally using the spare resources. If a low precision is required, even less filter coefficients than the above-mentioned M+1 filter coefficients can be used by assigning some of the M+1 filter coefficients as spare resources.

In an exemplary implementation of the apparatus, the spare resources comprise at least one additional filter coefficient; and the finite impulse response filter is configured to filter the values of the reference signal using the M+1 filter coefficients and the at least one additional filter coefficient to obtain the first filtered reference signal.

This provides the advantage that by using more than the M+1 filter coefficients for the filtering a higher accuracy of the filtering process can be obtained.

In an exemplary implementation of the apparatus, the apparatus comprises a combination element for combining the finite impulse response filter with the plurality of spare resources.

This provides the advantage that by the combination element the spare resources can be easily and efficiently added to the existing M+1 filter coefficients.

In an exemplary implementation of the apparatus, the controller is configured to send an enable signal to the plurality of spare resources and the combination element, the enable signal being configured to enable the plurality of spare resources and to enable the combination element.

This provides the advantage that the usage of the spare resources can be efficiently controlled by the controller.

In an exemplary implementation of the apparatus, the apparatus comprises: an analog front end configured to receive the received signal; and an analog-to-digital converter configured to convert the received signal processed by the analog front end into a digital representation.

This provides the advantage that the received signal can be efficiently converted in digital representation to be combined with the digital signal output of the digital FIR filter, i.e., the first filtered reference signal.

According to a second aspect, the disclosure relates to a method for determining filter coefficients for an echo compensation filter for reduction of an echo signal in a communication channel upon a basis of a received signal, the received signal being a receivable version of a known reference signal transmittable over the communication channel, the receivable version of the reference signal being affected by the echo signal, wherein an impulse response of the communication channel extends over N time intervals, the method comprising: filtering values of the reference signal, by using a finite impulse response filter having a set of M+1 filter coefficients to obtain a first filtered reference signal; selecting values of the reference signal associated with a k-th time interval of the N time intervals by an interval selector; successively delaying the selected values of the reference signal by M delay elements, the M delay elements being arranged after the interval selector; and determining, by M+1 error estimators, the M+1 filter coefficients in order to minimize a measure of a deviation between the first filtered reference signal and the received signal, wherein a first error estimator is coupled to an output of the interval selector, and wherein each of the remaining M error estimators is coupled to an output of a respective delay element.

Such a method provides the same advantages as the apparatus described above with respect to the first aspect. I.e., the method can advantageously reduce echo cancellation complexity due to the interval selection by the interval selector. The method significantly reduces the number of echo taps compared to a required number of echo taps when covering the full echo response. Compared to the full echo response compensation the same performance can be maintained when using the disclosed method.

According to a third aspect, the disclosure relates to a computer program product including computer executable code or computer executable instructions that, when executed, causes at least one computer to execute the method according to the second aspect.

Such a computer program product may include a non-transient readable storage medium storing program code thereon for use by a processor, the program code comprising instructions for performing the method or the computing blocks as described hereinafter.

The computer program product may run on a computer, e.g., a processor or a controller of a communication system using the wired-base data communication link 130 shown in FIG. 1.

Using such a computer program product improves efficiency of echo compensation due to reduction of number of echo taps.

### BRIEF DESCRIPTION OF THE DRAWINGS

Further embodiments of the disclosure will be described with respect to the following figures, in which:

FIG. 1 shows a schematic diagram illustrating a source of an echo signal 123 in a wired communication system 100;

FIG. 2 shows an exemplary impulse response 200 having an unforeseen echo 221, 222 due to lifetime of cable and connector;

FIG. 3 shows a block diagram illustrating an apparatus 300 for determining filter coefficients for an echo compensation filter according to the disclosure with short length of echo taps;

FIG. 4 shows a block diagram illustrating an apparatus 400 for determining filter coefficients for an echo compensation filter according to the disclosure with a segment shifting technique to cover all segments of echo response; and

FIG. 5 shows a schematic diagram illustrating a method 500 for determining filter coefficients for an echo compensation filter according to the disclosure.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

The devices and methods described herein may be configured to transmit and/or receive data over wired-based serial data communication link, for example according to IEEE 802.3, in particular IEEE 802.3cy for wired Ethernet. The original Ethernet uses coaxial cable as a shared medium, while the newer Ethernet variants use twisted pair and fiber optics links in conjunction with switches. The Ethernet standards comprise several wiring and signaling variants of the OSI physical layer (PHY) in use with Ethernet.

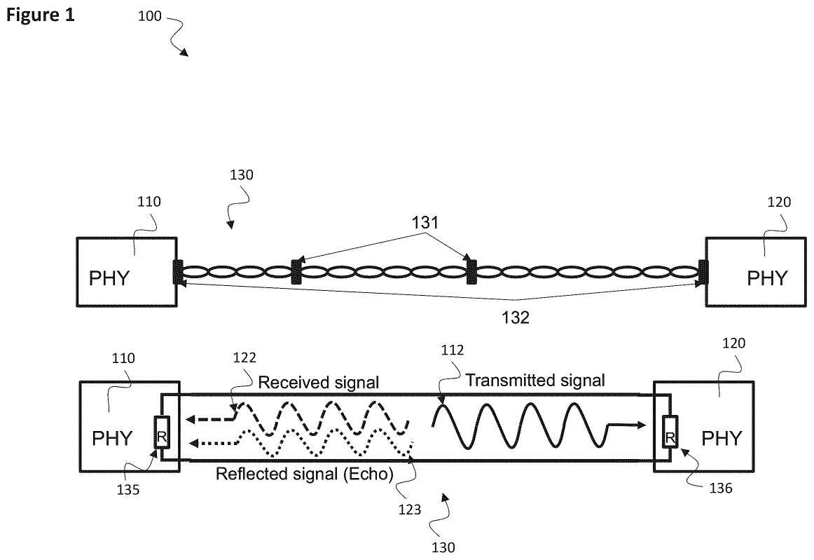

FIG. 1 shows a schematic diagram illustrating the source of an echo signal 123 in a wired communication system 100.

Two wired based high-speed serial communication PHYs 110, 120 exchange data over a wired-based data communication link 130. Each PHY 110, 120 may transmit and/or receive data. The length of the cable 130 may vary from a fraction of a meter up to a maximum length as defined by standards, e.g., IEEE 802.3, in particular IEEE 802.3cy. The length of the cable 130 varies from a fraction of a meter up to 100 m and higher. The cable 130 is usually divided into different segments and connected via inline connectors 131, 132. As the impedance changes at the connection point 131, 132 between cable and connector, the transmitted signal 112 is reflected back as echo signal 123. In full duplex communication systems, the reflected echo signal 123 is superimposed on the top of the received signal 122. The reflected echo signal 123 needs to be cancelled out at the receiver. The echo signal 123 can be significant and it can take quite some effort in terms of complexity and power consumption.

A line impedance 135 at the left-hand side of the cable 130, i.e., for PHY 110 may be 100 Ohms, for example. A line impedance 136 at the right-hand side of the cable 130, i.e., for PHY 120 may be 100 Ohms, for example. In one example, the wired data communication link 130 may comprise a shielded twisted pair cable.

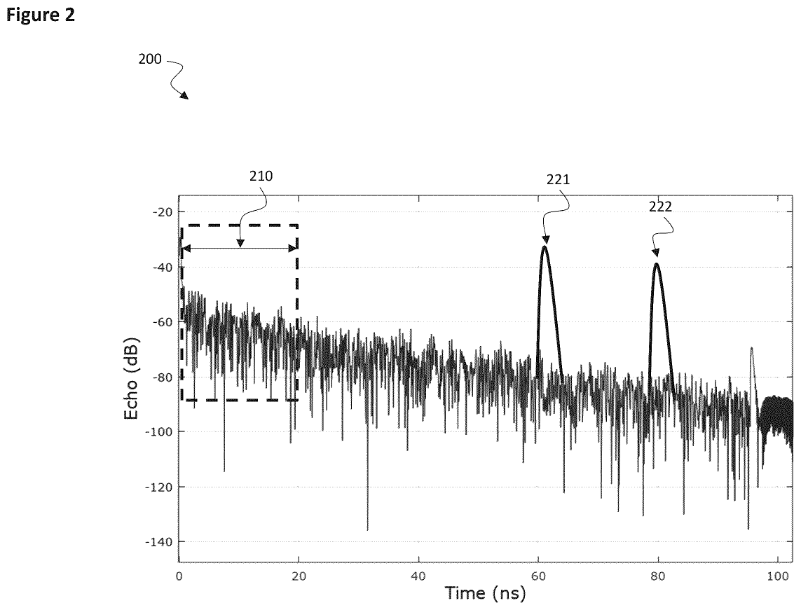

FIG. 2 shows an exemplary impulse response 200 having an unforeseen echo 221, 222 due to lifetime of cable 130 and connectors 131, 132 shown in FIG. 1.

Beyond 10 Gbit/s Ethernet PHYs, it is expected that the cable return loss quality increases. As the quality of the cable and the connector that are used in 25 Gbit/s technology is expected to be better, it may not be required to use a full length echo cancellation in terms of number of echo taps at the receiver. Instead, only a relevant window length 210 of echo needs to be cancelled and the rest can be left as noise as can be seen in FIG. 2. However, in a real-life use case the cable or connector may degrade over time and may result in unforeseen echo 221, 222 as depicted in FIG. 2. This results in SNR degradation and high chance of getting link instability with high bit-error-rate or the link may even drop. During the installation of the cable in the car, for example, the return loss specification can be passed but no one can give a guarantee over the life-time of car usages.

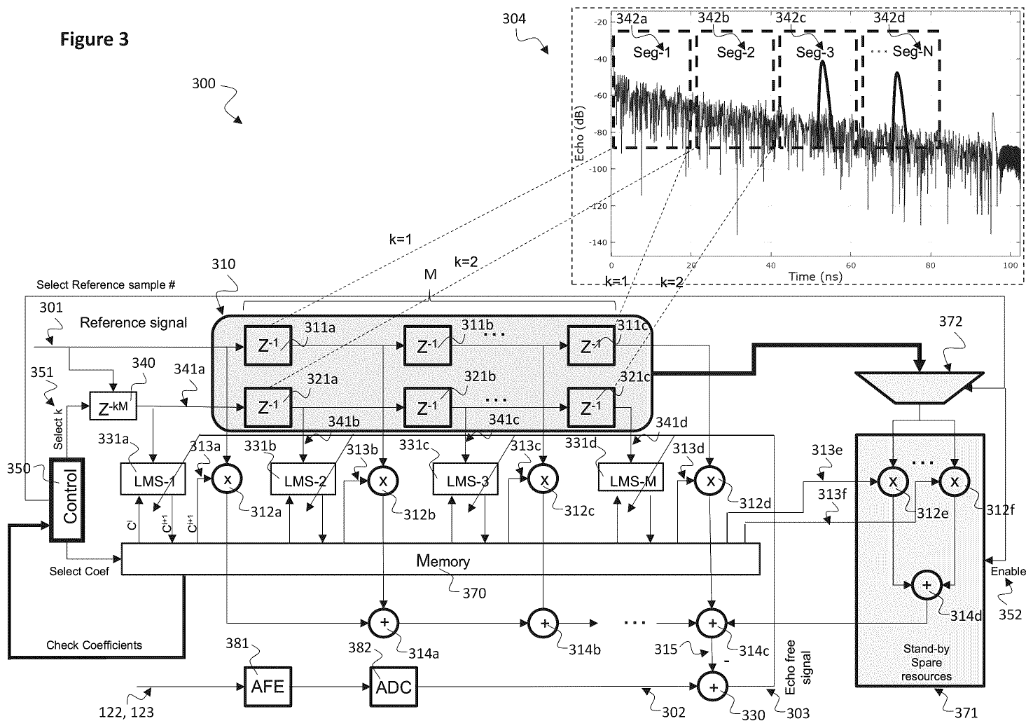

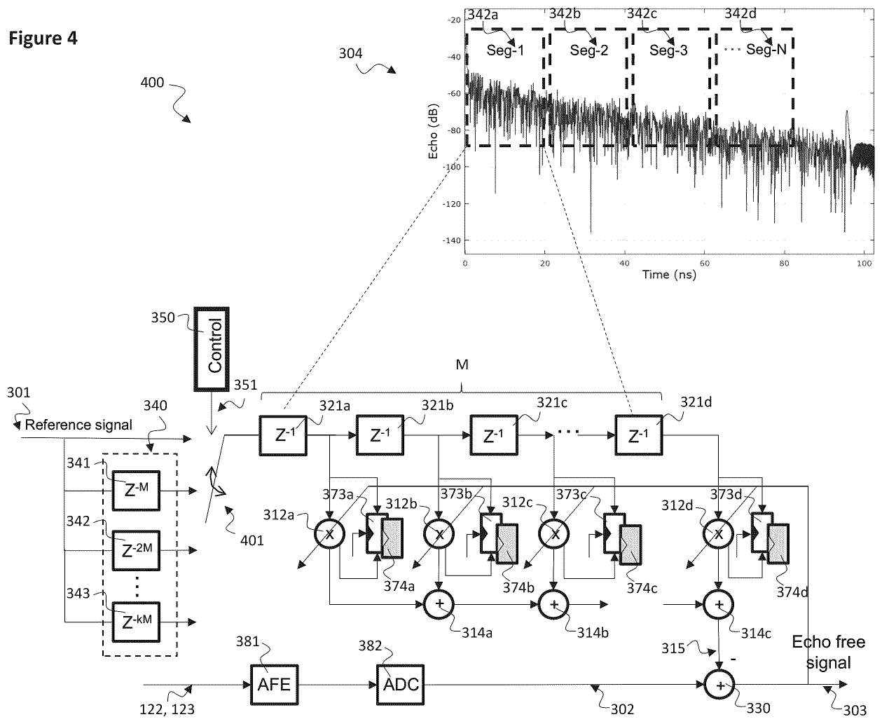

The disclosure presents a novel concept for echo cancellation with a reduced number of taps as described below with respect to FIGS. 3 and 4. This concept allows to compensate for echoes that may occur during the life-time of the car. It understands that the concept described in this disclosure is not limited to automotive use cases. It can also be applied in other use cases, e.g., consumer electronics or automation, etc.

FIG. 3 shows a block diagram illustrating an apparatus 300 for determining filter coefficients for an echo compensation filter according to the disclosure with short length of echo taps.

The apparatus 300 can determine filter coefficients for an echo compensation filter for reduction of an echo signal 123 in a communication channel 130, e.g., as shown in FIG. 1, upon a basis of a received signal 122. The received signal 122 can be a receivable version of a known reference signal 301 transmittable over the communication channel 130. This receivable version of the reference signal 301 can be affected by the echo signal 123, as shown in FIG. 1 or the echo signal 221, 222 shown in FIG. 2. An impulse response 304 of the communication channel 130 extends over N time intervals 342a-d as shown in the upper part of FIG. 3.

The apparatus 300 comprises a finite impulse response filter 311a-c, 312a-d, 314a-c having a set of M+1 filter coefficients 313a-d. The finite impulse response filter is configured to filter values of the reference signal 301 using the M+1 filter coefficients 313a-d to obtain a first filtered reference signal 315.

The apparatus 300 comprises an interval selector 340 for selecting values of the reference signal 301 associated with a k-th time interval of the N time intervals 342a-d.

The apparatus 300 comprises M delay elements 321a-c for successively delaying the selected values of the reference signal 301. The M delay elements 321a-c are arranged after the interval selector 340 as shown in FIG. 3.

The apparatus 300 comprises M+1 error estimators 331a-d. A first error estimator 331a is coupled to an output of the interval selector 340. Each of the remaining M error estimators 331b-d is coupled to an output of a respective delay element 321a-c. The M+1 error estimators 331a-d are configured to determine the M+1 filter coefficients 313a-d such that a measure of a deviation between the first filtered reference signal 315 and the received signal 122 is minimized.

M can be any integer number. A time interval may comprise a plurality of sample values, for example corresponding to the number of filter coefficients M+1. The number N of time intervals can be any integer number, for example greater than 1. The k-th time interval can be any of the N time intervals, e.g., selected by a controller.

The M+1 error estimators 331a-d can be mean squares error estimators, for example least mean squares (LMS) error estimators or minimum mean square estimators.

The measure of the deviation between the first filtered reference signal 315 and the received signal 122 may be a mean square deviation between values of the first filtered reference signal 315 and the received signal 122.

The apparatus 300 may comprise a memory 370 for storing the M+1 filter coefficients 313a-d for the values of the reference signal 301 selected by the interval selector 340.

The memory 370 may be configured to store the M+1 filter coefficients 313a-d for each time interval of the N time intervals 342a-d applied by the interval selector 340.

The memory 370 may be configured to store the M+1 filter coefficients 313a-d together with the value of the k-th time interval applied by the interval selector 340.

The M+1 error estimators 331a-d may be configured to determine the M+1 filter coefficients 313a-d for which the measure of deviation between the first filtered reference signal 315 and the received signal 122 is below a predefined threshold.

The apparatus 300 may comprise a subtractor 330 configured to determine the measure of deviation based on a subtraction of the first filtered reference signal 315 from a digital representation 302 of the received signal 122.

The apparatus 300 may further comprise an echo compensation filter having a set of N times M+1 filter coefficients (not shown in FIG. 3). The echo compensation filter may be configured to filter values of a transmit signal transmittable over the communication channel 130 by using the M+1 filter coefficients 313a-d for each time interval of the N time intervals 342a-d.

The apparatus 300 may comprises a controller 350 configured to send a select signal 351 to the interval selector 340 for selecting a value of the k-th time interval applied by the interval selector 340. By this controller 350, a respective time interval or time segment 342a, 342b, 342c, 342d of the channel impulse response 304 can be adjusted.

The apparatus 300 may comprise a plurality of spare resources 371, e.g. memory cells, for increasing the number of filter coefficients of the finite impulse response filter 311a-c, 312a-d, 314a-c.

The spare resources 371 may comprise one or more additional filter coefficients 313e, 313f. The finite impulse response filter 311a-c, 312a-d, 314a-c may be configured to filter the values of the reference signal 301 using the M+1 filter coefficients 313a-d and the at least one additional filter coefficient 313e, 313f to obtain the first filtered reference signal 315.

The apparatus 300 may further comprise a combination element 372 for combining the finite impulse response filter 311a-c, 312a-d, 314a-c with the plurality of spare resources 371. This combination element 372 can be a logic circuit for adding the spare resources to the FIR filter 311a-c, 312a-d, 314a-c and/or to the delay elements 321a-c.

The controller 350 may be configured to send an enable signal 352 to the plurality of spare resources 371 and the combination element 372. The enable signal 352 may be configured to enable the plurality of spare resources 371 and the combination element 372.

The apparatus 300 may further comprises an analog front end 381 to receive the received signal 122; and an analog-to-digital converter 382 to convert the received signal 122 processed by the analog front end 381 into a digital representation 302.

The apparatus 300 can detect and cancel echo without using full length of echo tap at the signal processing blocks. The controller 350 can provide smart echo cancellation with on-board diagnostic capability by controlling the behavior of the echo cancellation. In particular, the controller 350 can control a reuse of the limited number of echo taps to detect and cancel the echo that are spread over the echo response. The controller 350 can decide which of the detected echo needs to be cancelled and which of the detected echo can be left as un-cancelled echo. Once the coefficients reach its steady state value, the controller 350 can shift the window of the FIR filter from segment to segment, e.g., as illustrated in FIG. 4 in more detail.

In the following, an exemplary functionality of the apparatus 300 shown in FIG. 3 is described. The apparatus 300 can perform the following:

Divide the complete impulse response 304 into several segments as shown in FIG. 3: Seg-1 (342a), Seg-2 (342b), Seg-3 (342c), . . . . Seg-n (342d).

Reduce the number of echo taps allocation and allocate M taps for each segment.

Upper M^{th} delayer 311a, 311b, 311c is to compute the echo to be cancelled, while lower M^{th} delayer 321a, 321b, 321c is used to compute the coefficients and those computed coefficients are stored in the memory 370 as shown in FIG. 3.

Control block 350 controls in terms of checking the computed coefficients, selecting 351 the number of delayer to move the FIR filter to a particular segment. If additional resources are needed to compute the echo for the cancellation control blocks enable 352 the resources 371 that will be available as an accelerator.

Cⁱ is the current value of coefficient and Cⁱ⁺¹ is the new value of computed coefficient.

Let the algorithm 331a, 331b, 331c, 331d compute the coefficients for a segment until they reach to their saturation value, typical algorithm is least mean square (LMS) that is commonly used.

Coefficient saturation is detected based on sensitivity analysis, e.g., dC/dt=˜0. Store the index and the value of each coefficient into the memory 370.

These stored values are used to cancel the echo continuously for each received symbol for the visited segment.

Terms Z^{-M}, Z^{-2M}, and Z^{-KM} are set of delayers that help to move FIR filter from segment to segment as shown in FIG. 4.

All delayers Z^{-M}, Z^{-2M}, and Z^{-KM} may be filled from the beginning.

Once the first segment 342a reaches to its steady state value, FIR filter can move to second segment Seg-2 using the switch 401 shown in FIG. 4. The segments to be processed do not have to be in the same sequence as shown in FIG. 4. Any other sequence may be used as well, e.g., Seg-1, Seg-N, Seg-2, Seg-N-1; or Seg-1, Seg-N, Seg-3, Seg-2, etc.

The adaptive algorithm 331a, 331b, 331c, 331d readjusts the gain and reaches to steady state relatively early.

FIG. 4 shows a block diagram illustrating an apparatus 400 for determining filter coefficients for an echo compensation filter according to the disclosure with a segment shifting technique to cover all segments of echo response.

The apparatus 400 corresponds to the apparatus 300 shown in FIG. 3, where the interval selector 340 and the memory 370 is represented in more detail to illustrate the segment shifting technique that covers all segments, i.e., time intervals 342a, 342b, 342c, 342d of the echo response 304.

The interval selector 340 can be controlled by the controller 350 using a switch 401 to switch a respective segment, i.e., time interval 342a, 342b, 342c, 342d of the echo response 304. Depending on the selected value k, the reference signal 301 is delayed by 0, M, 2M, . . . kM samples.

The FIR filter comprises the M delay elements 321a, 321b, 321c, 321d and the M+1 multipliers 312a, 312b, 312c, 312d for applying the respective filter coefficients stored in the corresponding memory cells 373a, 373b, 373c, 373d for each of the time intervals 342a, 342b, 342c, 342d selected by the controller 350.

Note that in FIG. 4, the FIR filter is exemplarily represented by a number of four blocks of delay elements Z-1 and a corresponding number of filter coefficients while in FIG. 3, the FIR filter is exemplarily represented by a number of three blocks of delay elements Z-1 and corresponding filter coefficients. In both Figures, the length of the FIR filter corresponds to M+1 for covering a respective time segment 342a, 342b, 342c, 342d of the echo impulse response 304 as shown in FIGS. 3 and 4.

When the next time interval is selected by the switch 401 that is controlled by the controller 350, the next set of memory cells 374a, 374b, 374c, 374d is selected for FIR filtering as shown in FIG. 4.

The FIR filter provides the first filtered reference signal 315 that is subtracted from the digital representation of the received signal 122 including the echo signal 123 to obtain the echo free signal 303, also denoted hereinafter as the error signal, that is used by the adaptation algorithm for adjusting the filter coefficients. The received signal 122 passes the analog front end 381 and the ADC 382 to obtain the digital received signal 302.

When applying the LMS algorithm as an example for adjusting the filter coefficients, the steepest descent is determined to find the filter weights Ci, Ci+1 which minimize a cost function.

The LMS algorithm for an M-th order filter can be summarized as:
Parameters: M=filter order
   μ=step size
Initialization: C₀=zeros (M)
Computation: For n=0, 1, 2, . . .

$$X ( n ) = {[ x ( n ) , x ( n - 1 ) , … , x ( n - M + 1 ) ]}^{T} \\ e ( n ) = d ( n ) - {C}^{H} ( n ) x ( n ) \\ {C}_{n + 1} = {C}_{n} + μ e * ( n ) x ( n ) .$$

In this representation, X (n) corresponds to the reference signal 301, e (n) corresponds to the error signal 303 (or echo-free signal), d (n) corresponds to the digital representation 302 of the received signal 122.

Instead of using the LMS algorithm, any other algorithm may be used, e.g., Normalized LMS, RLS, Fast transversal filtering algorithms, LFTF algorithm, etc.

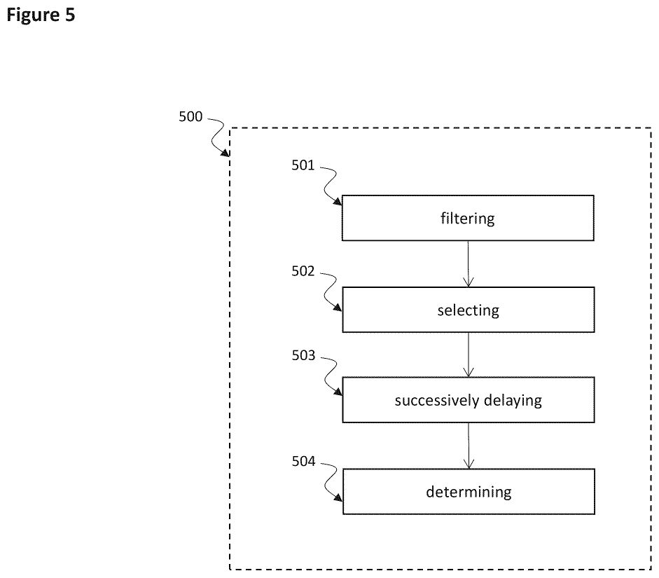

FIG. 5 shows a schematic diagram illustrating a method 500 for determining filter coefficients for an echo compensation filter according to the disclosure.

The method 500 determines filter coefficients for an echo compensation filter for reduction of an echo signal 123 in a communication channel 130 upon a basis of a received signal 122 as shown in FIGS. 1 to 4. The received signal 122 is a receivable version of a known reference signal 301 transmittable over the communication channel 130. The receivable version of the reference signal 301 is affected by the echo signal 123. An impulse response 304 of the communication channel 130 extends over N time intervals 342a-d as shown in FIGS. 3 and 4.

The method 500 comprises: filtering 501 values of the reference signal 301, by using a finite impulse response filter 311a-c, 312a-d, 314a-c having a set of M+1 filter coefficients 313a-d to obtain a first filtered reference signal 315, e.g., as shown in FIGS. 3 and 4.

The method 500 comprises: selecting 502 values of the reference signal 301 associated with a k-th time interval of the N time intervals 342a-d by an interval selector 340, e.g., as shown in FIGS. 3 and 4.

The method 500 comprises: successively delaying 503 the selected values of the reference signal 301 by M delay elements 321a-c, the M delay elements 321a-c being arranged after the interval selector 340, e.g., as shown in FIGS. 3 and 4.

The method 500 comprises: determining 504, by M+1 error estimators 331a-d, the M+1 filter coefficients 313a-d in order to minimize a measure of a deviation between the first filtered reference signal 315 and the received signal 122, wherein a first error estimator 331a is coupled to an output of the interval selector 340, and wherein each of the remaining M error estimators 331b-d is coupled to an output of a respective delay element 321a-c, e.g., as shown in FIGS. 3 and 4.

The present disclosure also supports a computer program product including computer executable code or computer executable instructions that, when executed, causes at least one computer to execute the performing and computing steps described herein, in particular the methods and procedures described above. Such a computer program product may include a readable non-transitory storage medium storing program code thereon for use by a computer. The program code may perform the processing and computing steps described herein, in particular the methods and procedures described above.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the present disclosure has been described with reference to one or more particular embodiments, those skilled in the art recognize that many changes may be made thereto without departing from the scope of the present disclosure. It is therefore to be understood that within the scope of the appended claims and their equivalents, the disclosure may be practiced otherwise than as specifically described herein.

What is claimed is:

1. An apparatus for determining filter coefficients for an echo compensation filter for reduction of an echo signal in a communication channel upon a basis of a received signal, the received signal being a receivable version of a known reference signal transmittable over the communication channel, the receivable version of the reference signal being affected by the echo signal, an impulse response of the communication channel extending over N time intervals, the apparatus comprising:
a finite impulse response filter comprising a set of M+1 filter coefficients, the finite impulse response filter being configured to filter values of the reference signal using the M+1 filter coefficients to obtain a first filtered reference signal;
an interval selector configured to select values of the reference signal associated with a k-th time interval of the N time intervals;
M delay elements configured to successively delay the selected values of the reference signal, the M delay elements being arranged after the interval selector; and
M+1 error estimators, a first error estimator of the M+1 error estimators being coupled to an output of the interval selector, each of the remaining M error estimators being coupled to an output of a respective delay element, the M+1 error estimators being configured to determine the M+1 filter coefficients such that a measure of a deviation between the first filtered reference signal and the received signal is minimized.

2. The apparatus of claim 1, wherein the M+1 error estimators are mean squares error estimators.

3. The apparatus of claim 1, wherein a measure of a deviation between the first filtered reference signal and the received signal is a mean square deviation between values of the first filtered reference signal and the received signal.

4. The apparatus of claim 1, comprising:
a memory configured to store the M+1 filter coefficients for the values of the reference signal selected by the interval selector.

5. The apparatus of claim 4, wherein the memory is configured to store the M+1 filter coefficients for each time interval of the N time intervals applied by the interval selector.

6. The apparatus of claim 4, wherein the memory is configured to store the M+1 filter coefficients together with the value of the k-th time interval applied by the interval selector.

7. The apparatus of claim 1, wherein the M+1 error estimators are configured to determine filter coefficients of the M+1 filter coefficients for which the measure of deviation between the first filtered reference signal and the received signal is below a predefined threshold.

8. The apparatus of claim 7, further comprising:
a subtractor configured to determine the measure of deviation based on a subtraction of the first filtered reference signal from a digital representation of the received signal.

9. The apparatus of claim 1, further comprising:
an echo compensation filter having a set of N times M+1 filter coefficients, the echo compensation filter being configured to filter values of a transmit signal transmittable over the communication channel by using the M+1 filter coefficients for each time interval of the N time intervals.

10. The apparatus of claim 1, further comprising:
a controller configured to send a select signal to the interval selector for selecting a value of the k-th time interval applied by the interval selector.

11. The apparatus of claim 10, further comprising:
a plurality of spare resources configured to increase a number of filter coefficients of the finite impulse response filter.

12. The apparatus of claim 11, wherein the spare resources comprise at least one additional filter coefficient; and
wherein the finite impulse response filter is configured to filter the values of the reference signal using the M+1 filter coefficients and the at least one additional filter coefficient to obtain the first filtered reference signal.

13. The apparatus of claim 11, further comprising:
a combination element for combining the finite impulse response filter with the plurality of spare resources.

14. The apparatus of claim 11, wherein the controller is configured to send an enable signal to the plurality of spare resources and the combination element, the enable signal being configured to enable the plurality of spare resources and to enable the combination element.

15. The apparatus of claim 1, further comprising:
an analog front end configured to receive the received signal; and
an analog-to-digital converter configured to convert the received signal processed by the analog front end into a digital representation.

16. A method for determining filter coefficients for an echo compensation filter for reduction of an echo signal in a communication channel upon a basis of a received signal, the received signal being a receivable version of a known reference signal transmittable over the communication channel, the receivable version of the reference signal being affected by the echo signal, an impulse response of the communication channel extending over N time intervals, the method comprising:
filtering values of the reference signal, by using a finite impulse response filter having a set of M+1 filter coefficients to obtain a first filtered reference signal;
selecting values of the reference signal associated with a k-th time interval of the N time intervals by an interval selector;
successively delaying the selected values of the reference signal by M delay elements, the M delay elements being arranged after the interval selector; and
determining, by M+1 error estimators, the M+1 filter coefficients in order to minimize a measure of a deviation between the first filtered reference signal and the received signal, wherein a first error estimator is coupled to an output of the interval selector, and wherein each of the remaining M error estimators is coupled to an output of a respective delay element.
